(19) United States
(12) Patent Application Publication
(10) Pub. No.: US 2002/0133445 A1
(43) Pub. Date: Sep. 19, 2002

(54) Methods and apparatuses for an online personal funding marketplace

(76) Inventor: Samuel Wharton Lessin, Englewood, NJ (US)

Correspondence Address: Brian P. Hopkins, Mintz, Levin, Cohn, Ferris,, Glovsky and Popeo, P.C., One Financial Center, Boston, MA, 02111, US

(21) Appl. No.: 09/930,313

(22) Filed: Aug. 15, 2001

Related U.S. Application Data
(60) Provisional application No. 60/275,974, filed on Mar. 15, 2001.
(60) Provisional application No. 60/291,226, filed on May 16, 2001.

(51) Int. Cl. G06F 17/60

(52) U.S. Cl. 705/36; 705/35

(57) ABSTRACT

A method for providing personal funding opportunities to Sellers via an online personal finding marketplace includes registering a plurality of requests for funding in an Seller database, each request being associated with a particular Seller and reasons for the funding request, dividing each request into at least one share in a respective Seller, each share being associated with a purchase price and an economic return for an owner of said share, wherein said economic return comprises a percentage of the respective Seller's potential future income, and wherein the purchase price comprises a representative amount of the funding request upon an initial sale of the share, registering a plurality of investors in an investor database, each registration including information related to an investor's mentoring capabilities, offering the purchase price to the owner of the share by an investor, wherein the offer comprises the purchase price and the investor's mentoring capabilities.

The present invention claims benefit under 35 U.S.C. § 119(e) of U. S. Provisional Patent Application Nos. 60/275,974 and 60/291,226, filed Mar. 15, 2001, and May 16, 2001, respectively. Each disclosure of which is herein incorporated by reference.

### BACKGROUND OF THE INVENTION

1. Field of the Invention

The present invention is directed to personal funding opportunities for individuals, and more particularly, to methods and apparatuses for funding individuals seeking capital and guidance.

2. Background of the Prior Art

There are generally two factors required in developing an idea or achieving a goal: capital and know-how. This is true whether the party involved is a corporation or an individual. Unlike corporations, however, most individuals lack the financial resources (or the ability to obtain financial resources) for developing their idea. Moreover, even if an individual is able to obtain capital, he usually lacks the experience and know-how to take the idea from concept to completion.

Currently, the government, banks, private institutions and non-profit organizations provide one avenue for individuals to obtain capital in the form of loans, grants and scholarships. Generally, when developing businesses and other ideas, individuals obtain capital by taking out a loan. Loans, however, are subject to the following drawbacks:

(1) Fixed rate of return.

No matter how well the result of the individual's business or idea, the return remains the same for the loan institution, defined by the market for loans/credit in general.

(2) Fixed Amount of Debt.

Loans also tie a fixed amount of debt to an individual. This often times scares individuals away from seeking funding since the individual owes back the money with interest over a period of time or by a particular date regardless of the outcome of his idea.

No matter what entity has provided capital to the individual, however, none provide the individual with knowledge and guidance resources for implementing, developing and completing the idea. Thus, individuals are left on their own in insuring the success of their idea. Often times the difference between success and failure is knowing which direction to go, whom it to call, and at what time. However, many individuals lack this knowledge as well as the personal/business network to bring their ideas to reality.

Thus, a number of the individuals whose ideas fail because of lack of adequate support and guidance are forced to declare bankruptcy. In order to compensate for such events, lending institutions increase their interest rates, which in turn makes it harder for individuals to obtain financing.

### SUMMARY OF THE PRESENT INVENTION

It is an object of the present invention to provide an online marketplace for the development and reward of human potential.

It is another object of the present invention to funnel resources from individuals having financial resources toward individuals who have the most potential, especially the investment arena.

It is yet another object of the present invention to create a networking and mentoring environment in which Applicants market their ideas to contributors and investors for funding in exchange for either a percentage of an Applicant's income when the idea is realized, in the case of an investor, or to return a percentage or multiple of the funding in the case of a contributor.

It is yet a further object of the present invention to deliver a large, diverse pool of Applicants, investors and contributors, provide the necessary procedures, agreements and associated documentation for facilitating the funding and the buying and selling of shares in Applicants, clearly communicating the parameters between investors and Applicants for the purchase of a percentage of an Applicant's future potential income.

It is yet another object of the present invention for a contributor to outright fund or give the Applicant the requested funding in exchange for nothing, in exchange for a percentage of the requested funding back (or the entire sum), or for a multiple of the contributed money back. Moreover, the present invention provides for contributors setting the parameters for which they will donate the money. Such parameters may include:

if the funding is for education, that the Applicant always maintain a specific grade point average, or that the Applicant donate consideration to a particular cause (e.g., donating an hour a week to a charity);

if the funding request is for a business, that the Applicant insure that a percentage of the business profits pay for a specific item (e.g., a percentage of the profits be donated to charity, and the like).

The present invention addresses the above concerns and objects and provides methods and systems for bridging the schism between an individual's potential and the resources needed to exercise that potential. Moreover, the present invention provides a potentially higher rate of return for investors and an increased chance of success for Applicants.

In a preferred embodiment of the present invention, a marketplace for personal funding opportunities is conducted over the Internet (or other computer network) via a Website where individuals requesting capital (Applicants) register their requests in an Applicant database. Potential Investors also register with the Website in an investor database, and conduct searches of the Applicant database for investment opportunities based on any criteria including: idea, Applicant personal information including profession, education, age, location, and the like. When an investor is interested in a particular funding request, the methods and systems according to the present invention enable the investor to provide some/all of the requested funding in exchange for a percentage (a “share”) of the Applicant's potential future income. Such shares may be bought and sold via the online marketplace at any point after the request for funding has been posted.

In addition to finding, investors provide mentorship to the Applicants in terms of advice, guidance, personnel and other networking opportunities/sources. Such mentoring not only provides a personal relationship between the Applicant and investor, but also provides an individual with sources of knowledge that will substantially increase the likelihood of his success. This “value added” aspect of mentoring is recognized with the present invention since it is in the best interest of the investor (economically) to see the individual succeed, and therefore, it is in the best interest of the investor to help the Applicant succeed by providing guidance.

Once one mentor has given all he has to offer an Applicant by way of guidance, he has most likely maximized the value of his shares as much as he can. At that juncture, it is in his interest to sell his shares to a person who can help the Applicant on a next level. Very simply, mentoring never ends for an Applicant; the system and his investors mature with him.

When shares are traded, the price of a share may be fixed being sold to the first investor searching the available shares. Preferably, however, share prices are bought and sold in an auction style environment. That is, shares are posted for investors to bid a price on over a predetermined time period. Accordingly, at the end of the time period, the share goes to the bidder submitting the highest price.

Accordingly, in first aspect of the present invention, a method for providing funding to an individual by an investor includes communicating a request for finding of an individual to an investor, and associating the request for finding with a cost for a share in the individual. The purchaser of the share receives an economic return comprising a percentage of the Applicant's income. The method also includes offering the share for sale, and purchasing the share by a purchaser at a purchase price. The purchase price may be the cost of the share.

In a second aspect of the present invention, a method for buying and selling a share in an individual includes communicating an offer for sale of a share in an individual for a first price by an owner of the share. Ownership of the share confers a percentage of the individual's income. The method also includes submitting at least one bid on the share by at least one purchaser, where the bid includes a second price, and communicating an acceptance of the bid at the second price. Ownership of the share is then transferred to the purchaser.

In a third aspect of the present invention, a method for selling shares in a marketplace is provided, where the shares include an interest in a future potential income of an individual. The method includes communicating an availability of a share for purchase to an investor for a minimum price and a mentoring ability and selling the share to an investor offering at least the minimum price and offering the highest mentoring ability.

In a fourth aspect of the present invention, a method for providing personal funding opportunities to Applicants includes registering a plurality of requests for capital in a database, where each request comprises a monetary amount and reasons for such request and each request is associated with a particular Applicant. The method further includes associating each request with an economic return to an investor providing the capital to the Applicant, the economic return includes a percentage of the Applicant's income, and providing a first Applicant with the respective requested capital by a first investor. The first investor also provides the first Applicant with mentoring.

Other aspects of the present invention are directed to computer readable media having computer code comprising instructions for performing the methods of the first four aspects of the present invention.

Still other aspects of the present invention are directed to systems having storage means for storing data and a processor programmed to perform the methods according to the first four aspects of the invention.

All of the above aspects will become clearer with reference to the accompanying figures and detailed description of the preferred embodiments that follows.

### BRIEF DESCRIPTION OF THE DRAWINGS

FIG. 1 is an illustration of an overview of a system for performing the methods according to the embodiments of the present invention.

FIG. 2 is a flowchart illustrating an exemplary process for registering with an online marketplace according to an embodiment of the present invention.

FIG. 3 is a flowchart illustrating an exemplary process for a Potential Investor to search for potential Applicants to find, according to an embodiment of the present invention.

FIG. 4 is a flowchart illustrating an exemplary process for a Potential Investor to make an offer to fund an Applicant, according to an embodiment of the present invention.

FIG. 5 is a flowchart illustrating an exemplary process for an Applicant to accept an offer from a Potential Investor, according to an embodiment of the present invention.

FIG. 6 is a flowchart illustrating an exemplary process for conducting an initial investor background search according to an embodiment of the present invention.

FIG. 7 is a flowchart illustrating an exemplary process for a Potential Investor in conducting an Applicant background search according to an embodiment of the present invention.

FIG. 8 is a flowchart illustrating an exemplary process for an Applicant in conducting a Potential Investor background search according to an embodiment of the present invention.

FIG. 9 is a flowchart illustrating an exemplary deal-making process for a Potential Investor to fund an Applicant according to an embodiment of the present invention.

FIG. 10 is a flowchart illustrating an exemplary deal-making process between a Potential Investor and Recipient according to an embodiment of the present invention.

FIG. 11 is a flowchart illustrating an exemplary deal-making process between a Potential Investor and Recipient, where the Recipient overrides a deal between the Potential Investor and a Share Holding Investor according to an embodiment of the present invention.

FIG. 12 is a flowchart illustrating an exemplary deal-making process between a Potential Investor and a Share Holding Investor according to an embodiment of the present invention.

FIG. 13 is a flowchart illustrating an exemplary deal-making process between Share Holding Investor and a Recipient, where the Recipient overrides the Potential Investor offer to buy, according to an embodiment of the present invention.

FIG. 14 is a flowchart illustrating an exemplary deal-making process between Share Holding Investor and a Recipient, according to an embodiment of the present invention.

FIG. 15 is a flowchart illustrating an exemplary process of payment to a Share Holding Investor from a Recipient, where the return is based on a percentage of the Recipient's income, according to one embodiment of the present invention.

FIG. 16 is a flowchart illustrating an exemplary process of payment to a Share Holding Investor from a Recipient, where the return is fixed, according to one embodiment of the present invention.

### DETAILED DESCRIPTION OF THE PREFERRED EMBODIMENTS

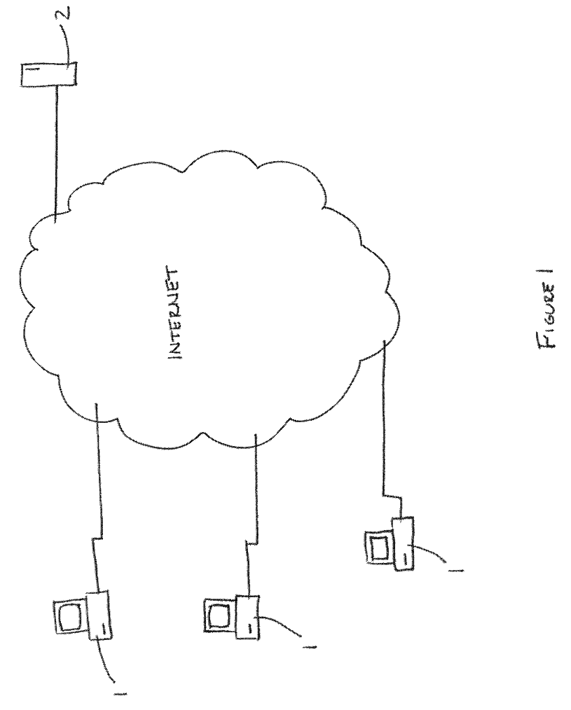

A marketplace for online personal funding according to the present invention is preferably operated over a computer network like, for example, the internet. To that end, an example of an Internet-based hardware implementation of the present invention is shown in FIG. 1. As shown in the figure, Applicants and contributors operating client computers 1 communicate with the Web server computer 2 of the marketplace administrator, preferably by visiting and interacting with the Web site located on the server. This process is typically initiated by the Applicant or contributor inputting, into his or her browser, the Uniform Resource Locator (URL) of the server Web site. In response to receipt of this communication from a participant's browser, software operating in the server computer 2 controls the server to send the browser the marketplace's home page form, generally a Hypertext Mark-up Language (HTML) document, having a menu of options to be discussed below. An interactive session ensues, which will be described in detail below with reference to a preferred embodiment, allowing an individual to register as an Applicant for requesting funding, as an investor for providing finding and to monitor the status of a request, the status of an offer, and the statuses of a contributor and Applicant.

The server computer 2 is programmed to format data, accessed from local or remote databases or other sources of data, for presentation to the Applicant or investor, preferably in the format discussed in detail below. The server computer 2, although described herein in the singular, may actually comprise plural computers cooperating to perform the functions described herein.

The server computer programming can utilize any conventional Web data interface technique or techniques, such as Common Gateway Interface (CGI) protocol and associated applications (or “scripts”), or Java “servlets” and java beans, i.e., Java applications running on the Web server. It will be appreciated that the interactive forms to be discussed below, which present forms for entry of information by the Applicants and contributors, and which save the entered information to a database, may be implemented in any of several conventional ways, using known server applications.

For example, in response to entry of the participant's name and password, the server can redirect the information to a CGI application that is called when the participant clicks, for example, a “submit” icon. Access to databases, both local and remote, containing, for example, Applicant information or information as to state of an offer for providing funding, also may be implemented, for example, by other CGI or similar applications.

In accordance with one of the preferred embodiments of the present invention, funding is provided in exchange for a percentage of the Applicant's potential future income. If the investor offers to provide the full funding requested, then, in exchange, the investor will receive a maximum percentage of the Applicant's income (theoretically up to 100%). Preferably, this percentage is less than 50% of the Applicant's future potential income, more preferably between one (1) and twenty-five (25) percent and most preferably between one (1) and ten (10) percent.

An important feature of the invention is the investor's ability to provide mentoring. Thus, the profile and background information of the investor may include a list of influential contacts that may be available for networking opportunities for the Applicant, company affiliations for possible employment opportunities, or the skills of the investor if the investor is a particular expert in the area in which the Applicant seeks funding (e.g., cardiac specialist for an Applicant seeking funding for medical school to specialize in cardiac medicine, etc.).

The review of offers may also include communications between the investor and Applicant, so that both are comfortable with each other prior to making the transaction. Although the investor and Applicant need not have a close personal relationship, such a relationship may be beneficial and an advantage to both the Applicant as well as the investor to improve the Applicant's potential future income as well as the investor's investment.

A plurality of investors may pool their resources and start a Share Holding Investment Group (SHG). Thus, the Group invests as though it were a single entity. In the online marketplace according to the present invention, once a Share Holding Investment Group is designated, any investor who is part of that group will have a Share Holding Investment Group table displayed when he logs onto the system.

Although the price of a share may be based solely on capital, it is preferable that the “price” of a share in the present invention include both a capital component and a mentorship component. Accordingly, each share(s) is preferably sold to the bidder submitting the “highest price” in terms of both capital and mentorship potential.

“Highest price” is not limited to include merely the highest monetary (funding) price, but rather a highest price may include both the highest capital as well as the highest mentoring potential. Highest price may also include a minimum mentorship component coupled with larger capital component, a minimum capital component coupled with unlimited mentorship component, and the like.

The present invention may also provide for behind-the-scenes business processes for evaluating potential Applicants and investors including consideration of assets, credit worthiness, age, profession, background, prior successes, and the like. Such business processes allow placing a potential value on a share of an Applicant and possible financial return.

In addition, the present invention may also provide for the necessary procedures and documentation for the agreements between the Applicants and investors, as well as between the Applicants, the investors and the online marketplace.

Accordingly, once a share of an Applicant is purchased by an investor, the investor may sell the share to another investor at a later time. Although it is within the scope of the present invention for such a share to be sold at any time after initial sale, legal requirements may necessitate investors to hold onto their shares for a period of time (e.g., two years).

In the present invention, an investor most likely holds onto most of his shares until he has maximized his influence and provided the maximum amount of guidance for the Applicant. At that point, it is in the investor's best interest to sell some or all of his shares to another investor who can provide additional mentoring beyond the initial investor's capabilities.

To effect subsequent sales of Applicant shares, the online marketplace provides a system similar to the NASDAQ stock market. Moreover, such a market may also be organized and operated like an online auction site similar to those currently available on the Internet (i.e., EBAY, Yahoo) to sell the shares to the highest bidder.

Depending upon the potential future income of the Applicant, the second purchase price is generally market determined and most likely at a higher initial price than the initial sale. Thus, if the funding for an Applicant is for a business plan that is foreseen to have great potential, the price of the share most likely will be higher based on bids that are received for the purchase of the shares.

Preferably, in the present invention, the Applicant is required to approve of the sale of shares to new investors. Since the present invention preferably establishes a bond between the

Applicant and the investor, such approval would insure that the Applicant personally get along with a new investor. However, it is within the scope of the invention that such approval not be required.

An Applicant may buy back his outstanding shares (or shares may be traded) at any time according to a market driven price, although there may be a holding period subsequent to a purchase as determined by law (e.g., two years). In addition, the present invention preferably incorporates a window of opportunity for an Applicant to buy back his shares at a predetermined price after a predetermined period of time has elapsed since the shares were originally sold. For example, the Applicant may repurchase shares in himself after two-years at a cost equal to five-times the original purchase price. Prior to the original purchase, these conditions may be negotiated, or pre-set according to the on-line marketplace.

In one of the preferred embodiments of the present invention where funding is provided to Applicants from Investors via an online web-based marketplace, the following user groups are distinguished:

Unregistered User. This is the default user category. Anyone who visits the Website is presumed to be an Unregistered User until they log in with a valid User ID and password. Unregistered users may access instructional and marketing materials at the site.

Applicant. An Applicant is an individual requesting funding. In addition to having the same navigation links as an unregistered user, an Applicant may now navigate through the Website, being able to update his/her profile, add supporting information and canceling registration (preferably if funding has not been provided).

In a preferred embodiment of the present invention, when an Applicant logs in to the Website, or registers for the first time, an Applicant is provided with information (or with links thereto) which includes webpage areas dedicated to instructions, a Potential Investor Table, and communication links with Potential Investors. The Potential Investor table generally includes a Potential Investor's name, communication links, new offers, and profile updates.

Recipient. A Recipient is an Applicant who has received some or all of his funding. The Recipient has all the abilities of an Applicant has, but can also communicate with Share Holding Investors (SHI) within the Recipient's Share Holder Group (SHG).

When a Recipient logs onto the marketplace website, a Potential Investor table may also be displayed as well as a Share Holding Investor table, listing the SHG. The Share Holding Investor table includes information regarding each SHI, the number of shares owned, and communication links..

Investor. One wishing either to invest in an individual for a fixed or variable return or one who wishes merely to provide financial resources to an individual for no return.

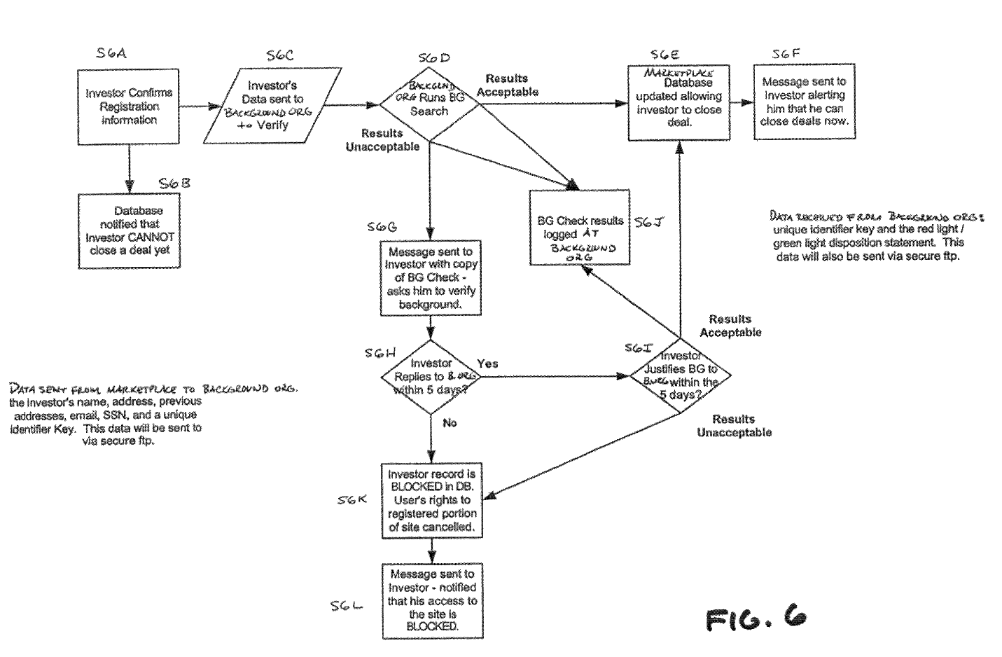

Potential Investor (PI). A Potential Investor is an Investor who has been authorized by to fund Applicants by the marketplace (i.e., the PI's background check has been completed and the PI has the minimal qualifications for providing funding). See FIG. 6.

When a Potential Investor logs onto the marketplace website, an Applicant Watchlist table is displayed. The Watchlist includes information regarding each Applicant, including each Applicant's name, the number of shares owned by the Applicant, and the amount of funds requested. The Watchlist may also include communication links for communicating with each Applicant (i.e., email, chat, instant messaging, phone). Other information that may be displayed includes a profile update indicator, which visually notifies the PI that a respective Applicant has updated their profile, the number of Share Holding Investors that the Applicant currently has, the number of shares owed by the Applicant's Share Holding Investors, and the number of new Potential Investors.

Share-Holding Investor (SHI). A Share Holding Investor is a Potential Investor who has invested in shares of an Applicant/Recipient. A SHI has all the abilities of a Potential Investor, and can communicate with Recipient's Share Holding Group.

A Recipient Relationship Table is displayed to Share Holding Investors, as well as an Applicant Watchlist table (see above). The Recipient Relationship Table includes information regarding the relationship between the Share Holding Investor and Recipients and other Share Holding Investors (if any). The Relationship Table may also include the Potential Investor Table for each relationship.

Share Holding Group (SHG). All of the Share Holding Investors of a Recipient. The SHG is generally displayed to a Recipient when he accesses the marketplace website.

Administrator. An Administrator is an individual or group who operates and maintains the Website according to the present invention. Not all Administrators have equal status and thus access to the site and administrative modules may vary.

Access & Navigation

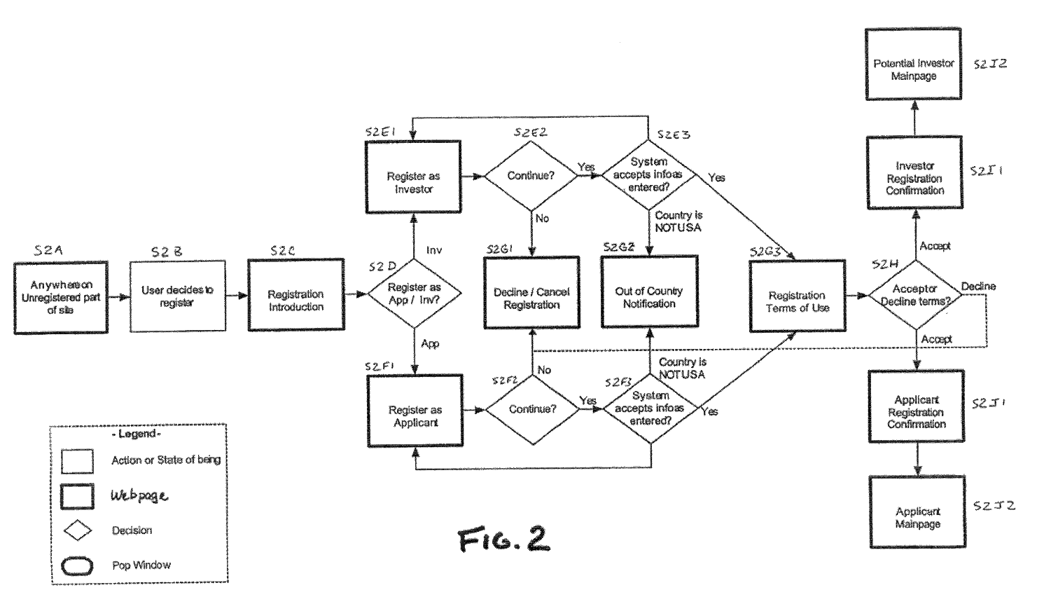

Unregistered/unlogged-in users may navigate through the Website and access, for example, links to the Marketplace Homepage, registration, more information, browsing Activated Potential Investor list, and login, as well as links to the terms of use of the Website, privacy considerations, security, feedback, and a sitemap. Blocks S2A-S2J2 of FIG. 2 illustrate the registration process for one embodiment of the present invention.

Marketplace Website Registration

A user may register at any point while visiting the marketplace website according to the present invention. Upon clicking on a registration link, the user is directed to a registration introduction page, which includes detailed information on how to register (S2A-S2C).

The user is given a choice to register as an Applicant or an Investor (S2D). Thereafter, the user is directed to a registration area for either an Applicant or an Investor, at which point the selection is checked to insure that the user has selected the appropriate icon (S2E2/S2F2). After the user has entered their personal information, the system checks to see if the user is in the proper jurisdiction for participating in the marketplace. Thus, if the user is out of the operational jurisdiction of the marketplace, an out of jurisdiction notification is presented to the user (S2E3,S2F3,S2G1,S2G2).

If the user is in the proper jurisdiction, information regarding the terms of use of the marketplace are presented to the user (S2G3), at which point the user must accept or decline the terms (S2H). Upon acceptance (S2I1,S2J1), registration of the user as either an Applicant or an Investor is confirmed, and the registered user is then directed to a main Webpage for an Applicant or Investor (S2I2,S2J2).

In order to register as an Investor, the user must enter identification information in appropriate fields supplied at the Investor registration page. Such information generally includes the name, address, phone number and social security number.

Moreover, accredited information should also be entered relating to income, as well as other information including, but not limited to, the amount of investible assets, profession, employer, title, industry experience, years of experience, retired, education, and the like.

A field may also be included detailing the size of the investment or contribution that the investor desires to fund, and a field to indicate the level of involvement. The level involvement can range from no contact, some contact, some contact with possible connections and mentorship.

To register as an Applicant, the user enters identification information including name, address, email address, phone number, social security number, username and password and the like. Other information may also be requested directed to previous addresses, schooling, and more importantly, the amount of the requested funding and the reason for the funding.

Thereafter, registration of the user as an Investor or Applicant is verified.

The supporting information of either a registered Applicant or a registered Potential Investor may be modified by adding text, pictures, and other information including URLs which direct one to a Webpage containing information related to the Applicant/investor.

This information may be viewed by interested parties; e.g., Applicants may look at prospective Investors by viewing their supporting information, and Investors may look at prospective Applicants viewing their supporting information.

Search for Applicants

An investor who registers with the market place visits the market generally to determine if there are any potential Applicants that she may want to supply requested funding. Accordingly, the investor selects a link on the marketplace's home page which directs the investor to a query Webpage for finding Applicants.

The investor enters information in a query field representative of the type of Applicant she wishes to provide funding. For example, the investor may wish to invest in Applicants who request funding for education, and more particularly, the investor may wish to invest in Applicants wishing to pursue a technical education such as engineering or computer science.

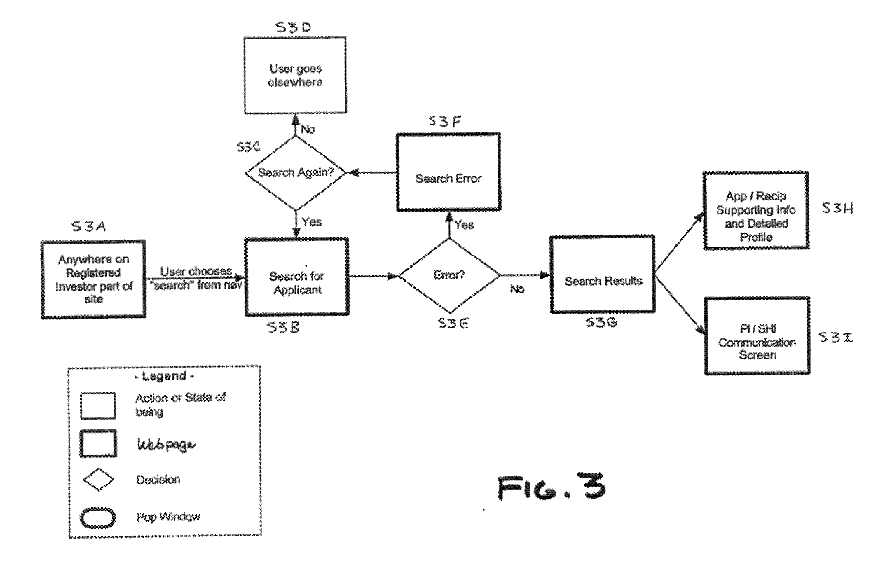

Accordingly, after the Investor enters the query information, a search of the Applicant database is conducted and a list of Applicants associated with the searching criteria is returned. From there, the investor reviews the Applicants and their supporting information. Blocks S3A-S3I of FIG. 3 is an example illustrating such a search.

As shown a Potential Investor selects an icon labeled “Search” (S3A) which directs the PI to a query screen upon which the PI enters search terms for finding a particular Applicant. Although a search may return an error (S3E,S3F), and go elsewhere on the website (S3D), the results of the search are displayed to the PI (S3G). At this point, the PI may select and view the supporting and detailed information of any one of the Applicants found in the search, and/or send an Applicant a communication (S3H,S3I).

Potential Investors may then select certain Applicants which they have reviewed from their query of potential Applicants, and add them to their Watchlist, which (as earlier described) is displayed to the Potential Investor when This watch list is then displayed when the Potential Investor logs onto the system.

Offers for Supplying Funding

Although a Potential Investor may simply select the first Applicant and supply the Applicant with the requested funding, the investor may want to maximize his investment by investing in those Applicants in which the investor may provide guidance, advise and networking opportunities; i.e., mentorship.

An Applicant may receive more than one offer, thus, the review of the background information about each investor is crucial in selecting the investor the Applicant feels most comfortable with. However, the offers may be only for a portion of the total funding request, and thus, the Applicant may accept offers for funding from a number of investors to fulfill the entire funding request.

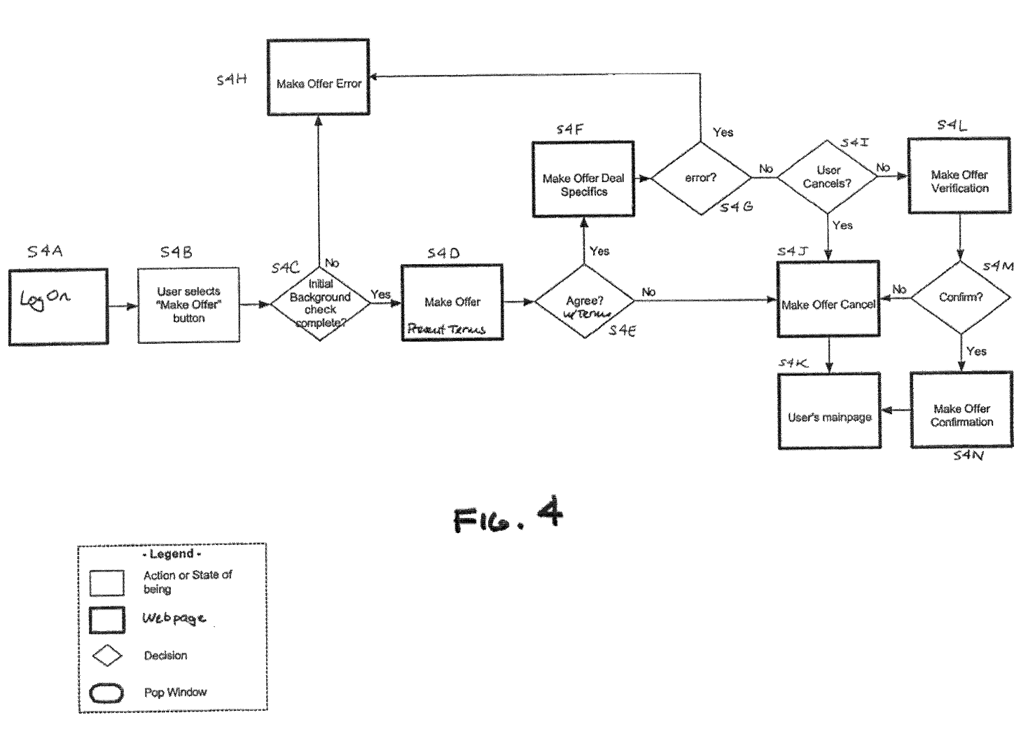

FIG. 4 illustrates a flowchart depicting the process of making offers from a Potential Investor to purchase shares from an Applicant/Recipient or to purchase shares from a Share Holding Investor (SHI) in a preferred embodiment of the present invention. After a Potential Investor or a Share Holding Investor logs onto the system (S4A), the user selects a “Make Offer” icon for a particular Applicant, Recipient or Share Holding Investor to purchase share(s) at a particular price (S4B). If an initial background check has been completed (S4C), then terms regarding the supply of funding are presented to the Potential Investor (S4D). If the PI agrees to the terms (S4F), then deal specifics are entered (the amount the offer, the number of shares (S4F)). In this embodiment, the PI may also provide any additional comments to the Applicant. Such comments may include specific mentoring capabilities of the PI.

As also shown in FIG. 4, if the deal specifics may cause the system to return an error for reasons such as entering a number of shares that are greater than what is available, or too low of an offering price, and the like (S4G,S4H).

The offeror may still cancel his offer after making the deal specifics (S4I. If so, the user is returned to his main-page (S4J,S4K). If the offeror confirms the offer, then the user is asked to verify and confirm the offer (S4L,S4M). When the offer is confirmed, it is communicated to the offerree and the offeror is returned to his main-page (S4N,S4K).

Thereafter the offer is communicated to the Applicant/Recipient or Share Holding Investor, via an email message. Upon receiving the communication, the party receiving the offer may accept the offer.

Offer Acceptance

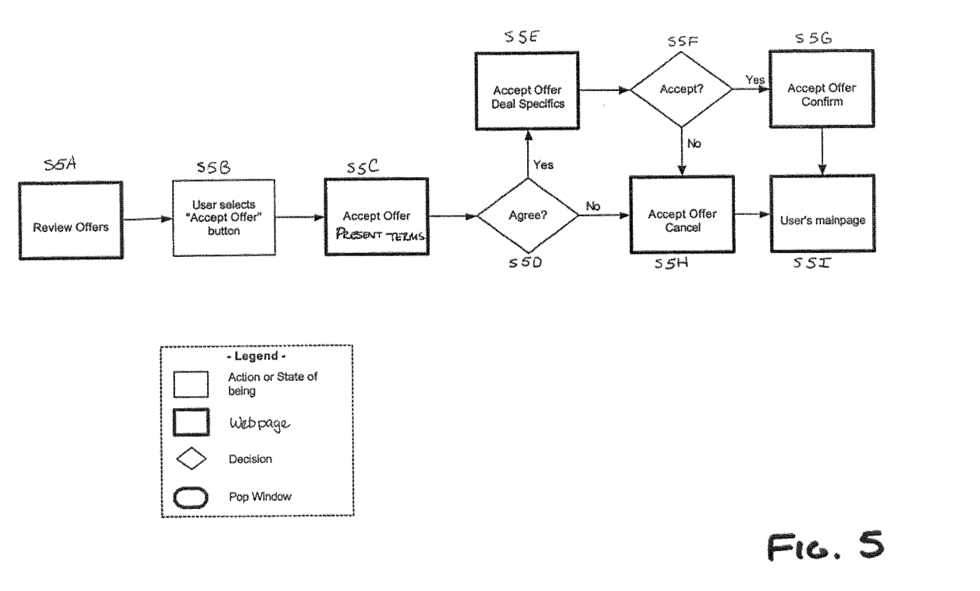

FIG. 5 illustrates a flowchart of the process of accepting an offer. The Applicant (Applicant/Recipient or Share Holding Investor) reviews offers that he has received (S5A), at which time he accepts an offer from a particular Potential Investor (S5B). Terms of use are displayed to the offeree explaining the terms upon acceptance of the offer (S5C). If the Applicant accepts the terms, the deal specifics are presented to the Applicant (S5D,S5E). If the Applicant does not accept, the offer is canceled (S5H), and the Applicant is directed back to his main-page (S5I). If however, the terms have been accepted, the Applicant then must determine if he likes the specifics of the deal (S5F), at which point the Applicant confirms the acceptance (S5G), if not the acceptance is canceled (S5H). Thereafter the Applicant is directed to his main-page (S5I).

Background Check

Prior to Potential Investors making offers, or Applicants accepting offers, each may request that a background check be conducted on the other. Moreover, the marketplace according to the present invention might include a policy of requiring a background check of Applicants as well as investors prior to being registered. Accordingly, example methods of conducting such background clearances are shown in FIGS. 6-8.

Blocks S6A-S6L of FIG. 6 illustrate the process of an initial Investor background check. As shown, upon an Investor confirming registration information (S6A), the system informs the Investor (S6B) that deals with Applicants may not be closed prior to a background clearance check. The present invention relies upon current methods and standards for approval of an individual/group for investment of a particular amount of finding.

The Investor's information is forwarded to a background searching firm to verify the Investor's information (S6C-S6D). If the results are acceptable, the marketplace allows the Investor to proceed with closing deals with Applicants/Recipients (S6E-S6F), and the information is logged (S6J).

If the results are unacceptable, a message is sent to the Investor to verify the information (S6G). A time limit is imposed (e.g., five days) and if the Investor justifies his background within the time period, then the Investor is allowed to proceed with deals (S6G-S6I). If not, the Investor is blocked from closing deals (S6K). Moreover, he may also be unregistered and no longer allowed to access the marketplace (S6L).

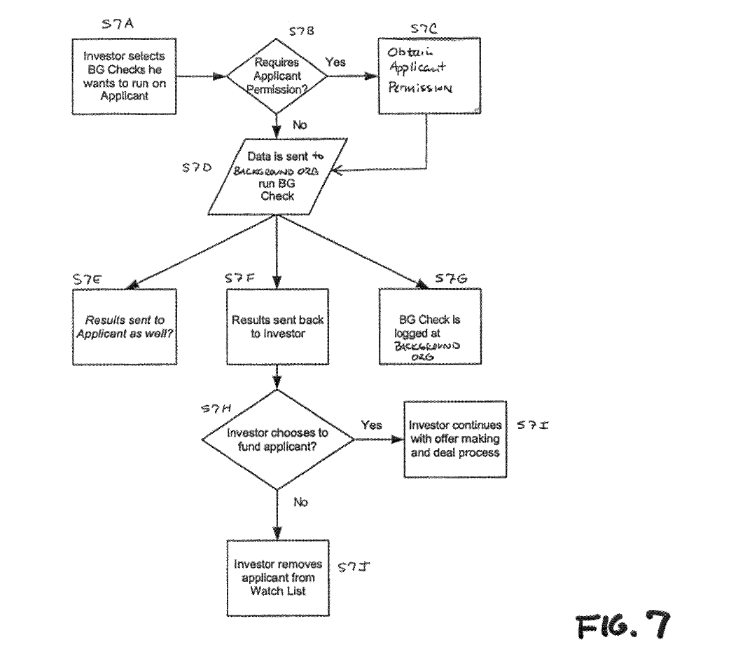

Blocks S7A-S7J of FIG. 7 illustrate a background check of an Applicant. A Potential Investor selects an Applicant to have a background check conducted (S7A). Depending upon the Applicant, authorization by the particular Applicant may be required (S7B). If so, Applicant permission must be obtained (S7C). The data is forwarded to the background firm which conducts the check (S7D). The results may be returned to the Potential Investor as well as the Applicant (S7E,S7F) and logged (S7G). If the Potential Investor chooses to proceed with finding the Applicant, he continues with the deal making process. (S7I). Otherwise, the Potential Investor removes the Applicant from his Watch List (S7J).

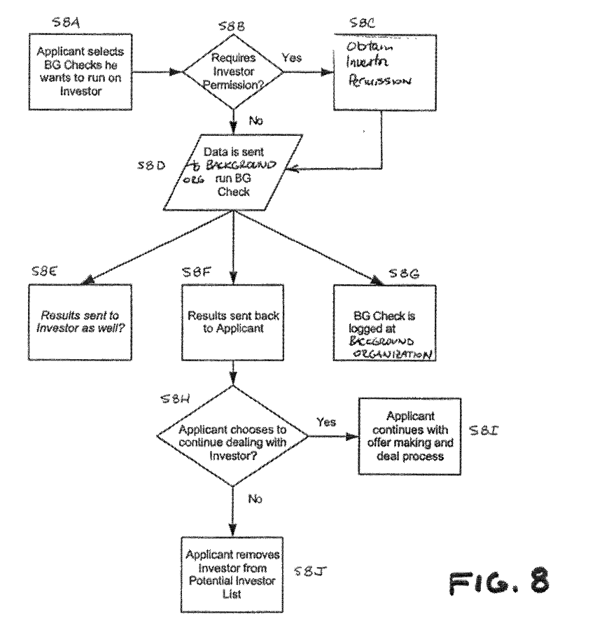

A similar process for checking into the background of a Potential Investor by an Applicant is shown in blocks S8A-S8J of FIG. 8.

Acceptance of Offers

After the Applicant has reviewed all offers, the Applicant most likely accepts the offer of a particular PI(s) and sends a communication to the PI. Preferably, a copy of the communication is sent to the administrator of the marketplace so that the legal and financial mechanisms for perfecting the transfer of funds and awarding of shares my be initiated. Blocks S5A-S5I of FIG. 5 illustrate an acceptance process for accepting an offer according to one embodiment of the present invention.

Deal-making Processes

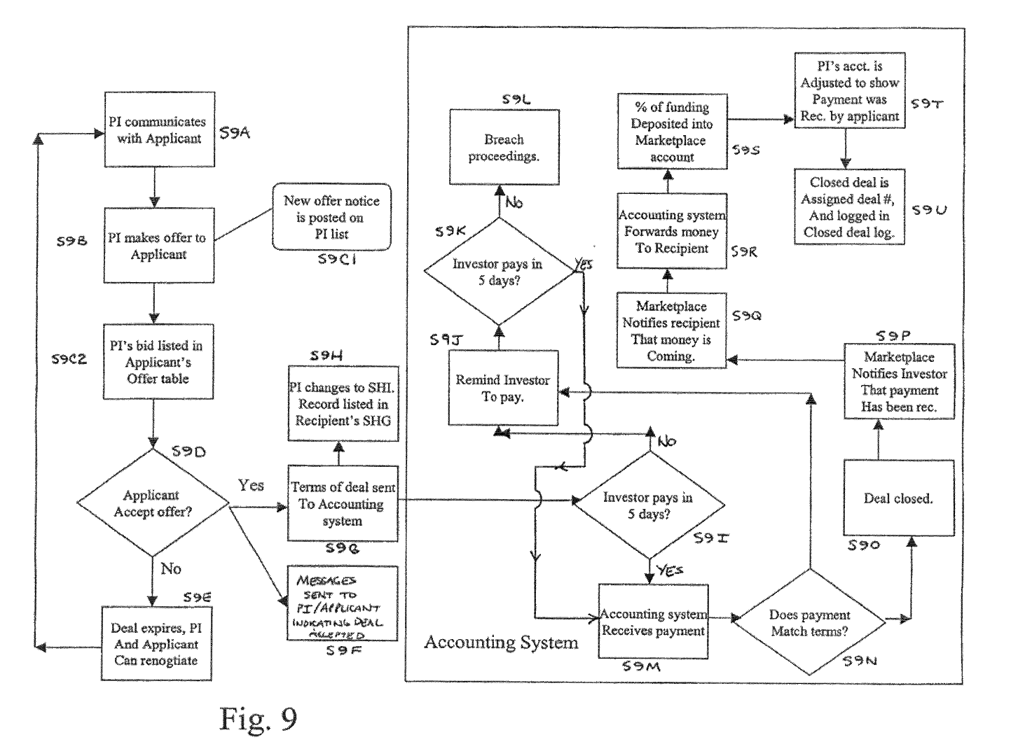

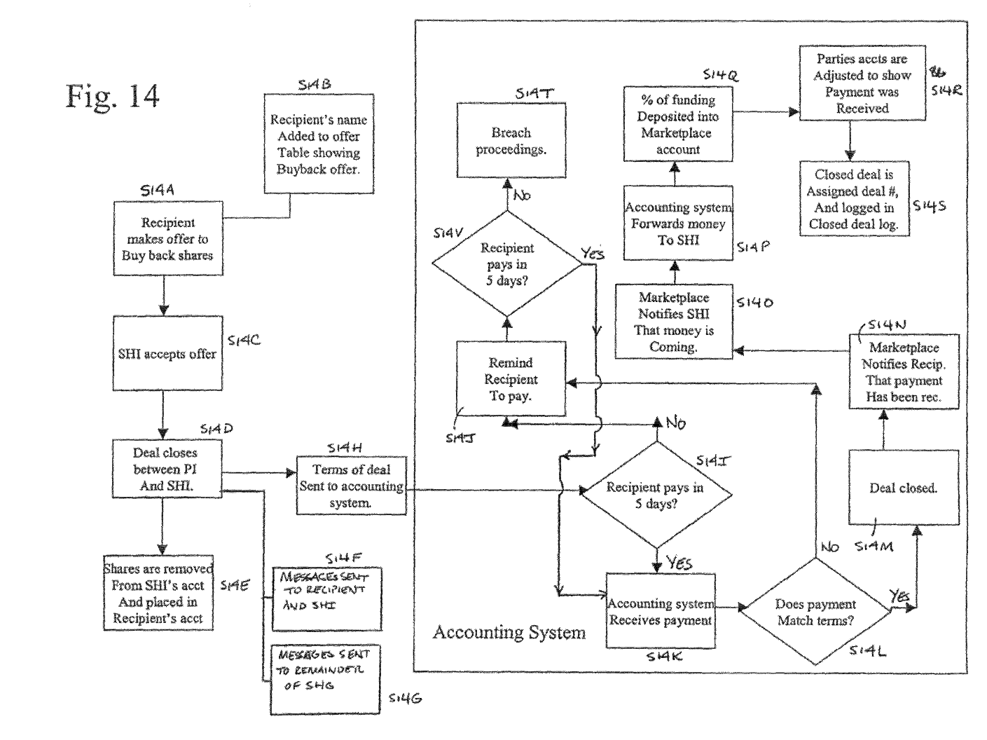

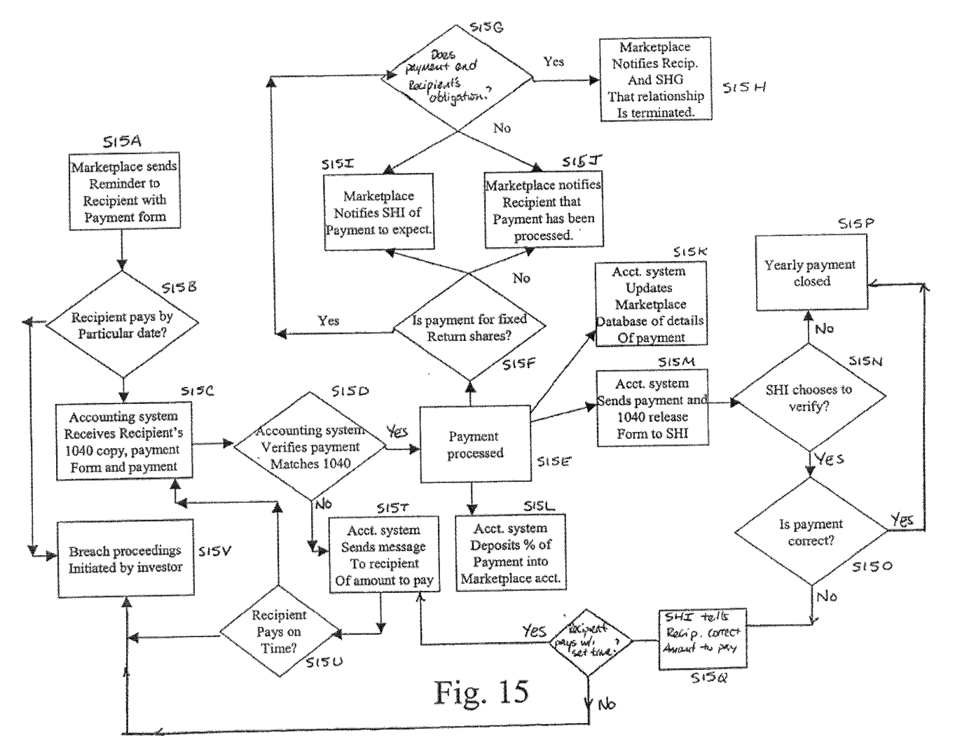

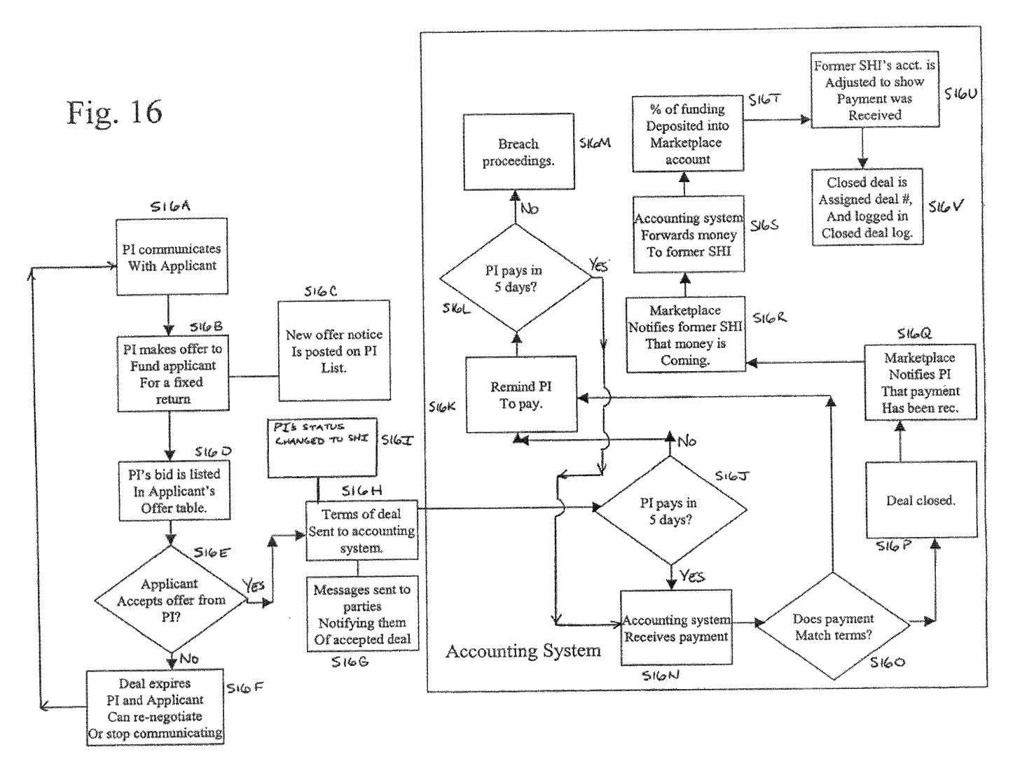

FIGS. 9-20 illustrate various deal-making flowcharts which are transacted through the marketplace according to an embodiment of the present invention. Each figure refers to specific email messages (e.g., E1-E62) and notices (M1-M13), the content of which follows.

Deal-making Between Potential Investor and Applicant

FIG. 9 depicts the deal-making process between a Potential Investor (buyer) and an Applicant (seller). A Buyer communicates with the Seller (S9A), and thereafter makes an offer to the Seller (S9B). The new offer is displayed on the Applicant's Potential Investor List (S9C), and a communication is forwarded to the Seller notifying the Seller of the offer and indicating an expiration date of the offer. When the Seller accepts the offer (S9D) form the Buyer, a message is sent to the Buyer and the Seller notifying each that the deal has been accepted. If the Seller does not accept the offer, the deal expires in which case the Buyer may re-negotiate with the Seller and make a new offer (S9E).

Terms of the deal are sent to an accounting system, for management of the transaction (S9G), and the status of the Buyer changes from Potential Investor to a Share Holding Investor. Thereafter, the Seller's status changes from Applicant to Recipient, and the Share Holding Investor is listed in the Recipient's Share Holding Group table (S9H).

An accounting system takes over and coordinates and monitors the progress of the deal. If the PI forwards payment within a predetermined period of time (e.g., five days), and the payment reflects the terms of the deal, the deal is closed and the marketplace website according to the present invention notifies the PI and the Applicant that payment has been received. Thereafter, the money is transferred to the PI (see S9I-S9U).

In a preferred embodiment, the marketplace profits from the buying and selling of shares and charges a predetermined percentage for the transaction. Thus, at the close of the above deal, a percentage of the funds received would be forwarded to the marketplace operators (S9S).

If payment is not received within the predetermined time period, the marketplace website is notified, who then reminds the PI (S9J). The PI may be given an additional time period to pay (e.g., five more days), if payment is made, the process proceeds as outlined above (S9K). If the Buyer still does not pay, the breach of contract proceeding may then be initiated by the Seller (S9L), and notifications are forwarded to the Applicant and the PI.

If the Buyer effects payment, but not to the satisfaction of the deal, then the accounting system notifies the Buyer of the remaining amount to pay (S9J), and message are sent to this effect. The Share Holding Investor may be given an additional period of time to pay (e.g., 5 more days), at which point if the Buyer sends in the remaining amount, the deal proceeds, if not, the Seller is notified of his right to initiate breach of contract proceedings.

Deal Making Between Potential Investor and Recipient

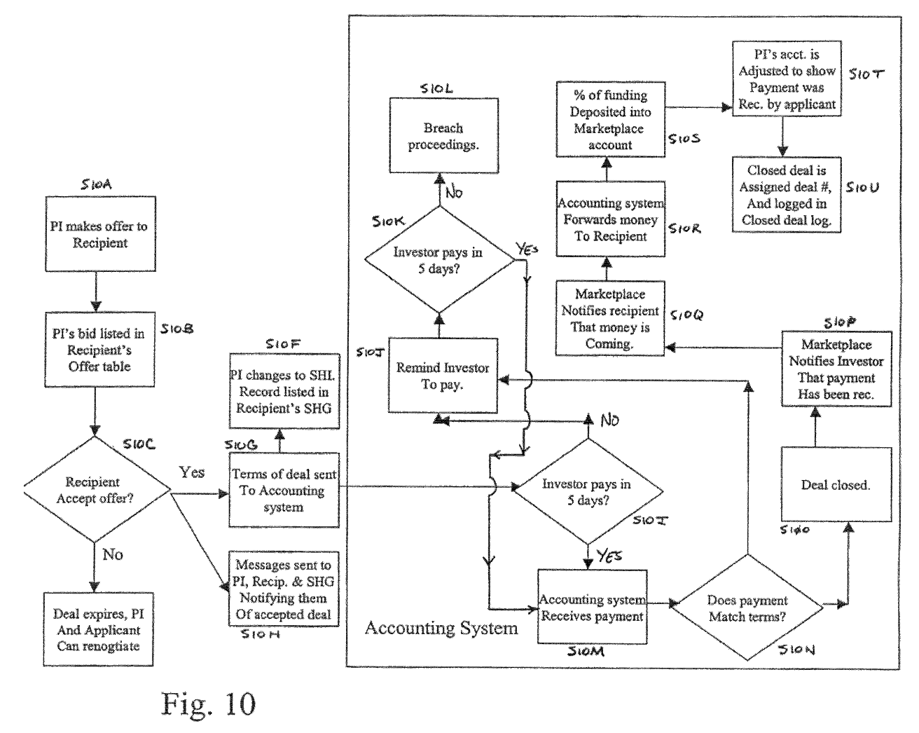

FIG. 10 illustrates the deal-making flowchart between a Potential Investor and a Recipient. After a Potential Investor has made an offer to a Recipient (S10A), the offer is posted on the Potential Investor list (S10B). If the Recipient accepts the offer (S10C), the deal is closed, and the status of the Potential Investor with regard to the Recipient changes to Share Holding Investor, and the new Share Holding Investor is then listed in the Recipient's Share Holding Group (S10F). The new Share Holding Investor's listing in the Share Holding Group may be color coded to indicate that payment has been received.

Messages are sent notifying the Potential Investor, the Recipient and the remainder of the Share Holding Group that the deal has been accepted (S10H). The accounting system is notified with the specifics of the deal (S10G), and performs the same process (S10I-S10W) for transferring payment from the Potential Investor to the Applicant/Recipient as was outlined above for the deal-making flow between a Potential Investor and an Applicant (see FIG. 9).

Deal-making Between Potential Investors and Recipients-over-riding Share Holding Investor (SHI)

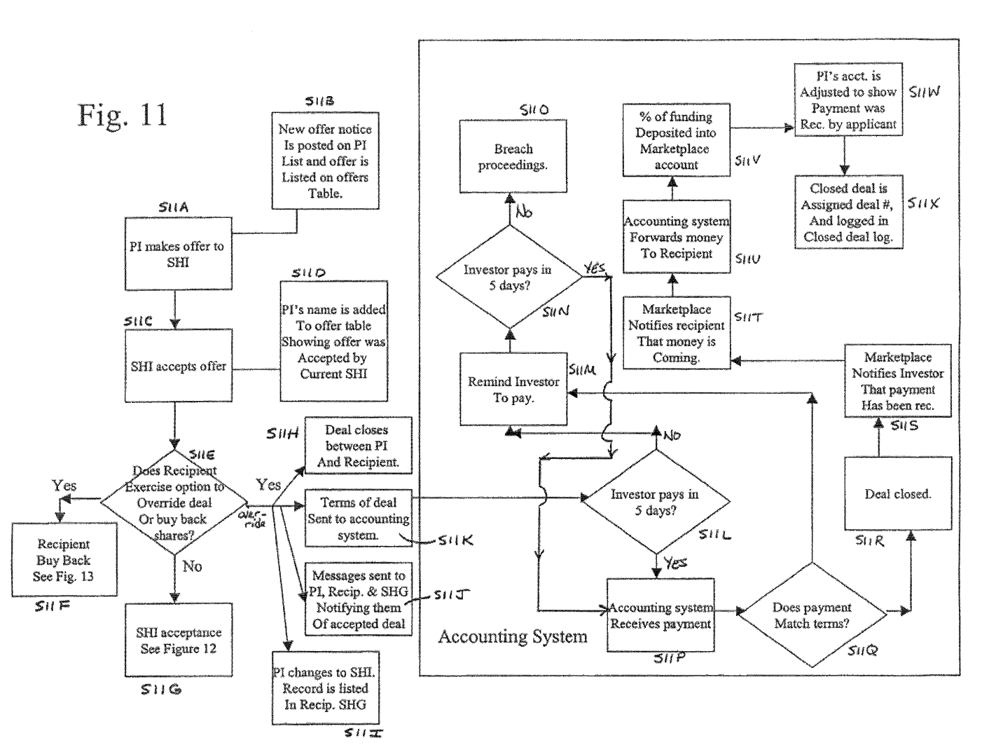

FIG. 11 illustrates an example of the deal-making flow between a Potential Investor and a Recipient, when the Recipient overrides a potential deal between a Potential Investor and a Share Holding Investor, for an offer by the Potential Investor. The Potential Investor offers to purchase one or more shares of an individual from a Share Holding Investor (S11A). The Potential Investor's name is posted on the Potential Investor List and the offer is listed on a list of current offers (S11B). The Share Holding Investor accepts the offer and messages are sent to both parties as well as the Recipient (S11C). The new Share Holding Investor's name is color coded on the offer table to indicate that the offer was accepted (S11D). At this point, the Recipient may exercise a right to accept the deal thus overriding the SHI (if the Recipient still has outstanding unsold shares), buy back his share(s), or not exercise any rights and allowing the deal between the Potential Investor and the Share Holding Investor to proceed (S11E). This option generally must be made within a predetermined period of time (e.g., five days).

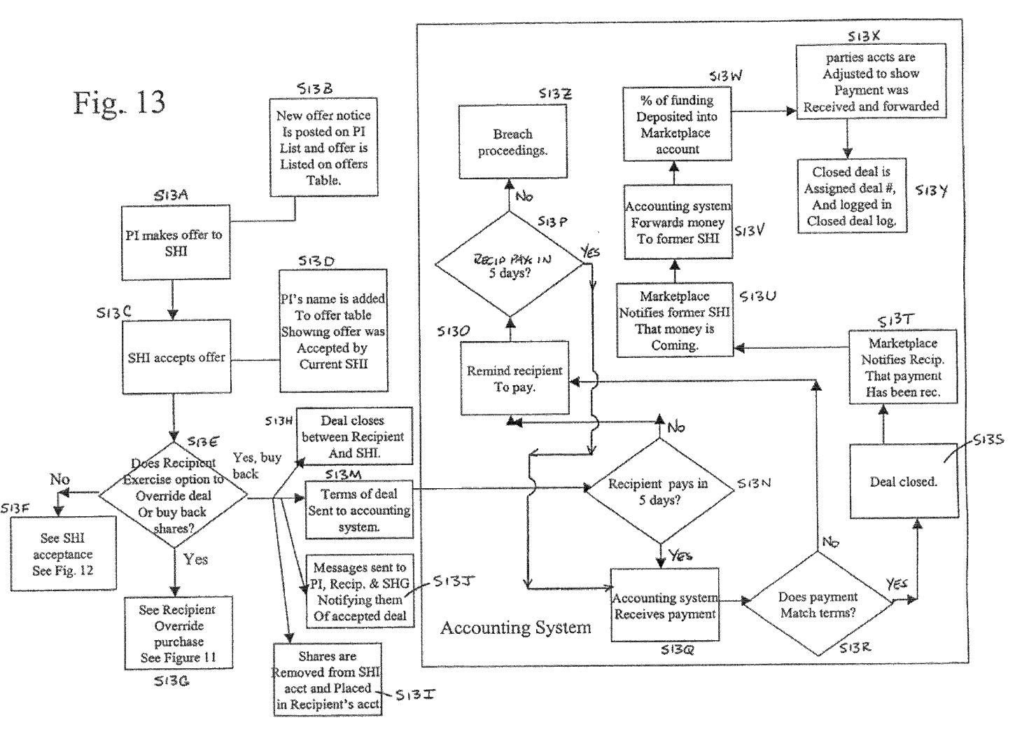

If the Recipient wishes to buy back the share(s), the deal-making process proceeds according to FIG. 13 (S11F). If the Recipient over-rides the deal between the Potential Investor and the SHI, then the deal closes between the Potential Investor and the Recipient (S11H), the status of the Potential Investor changes to a Share Holding Investor (S11I). Messages are sent to all parties (S11J). The terms of the deal are forwarded to the accounting system which follows the same process as outlined in FIGS. 9 and 10 (S11L-S11X).

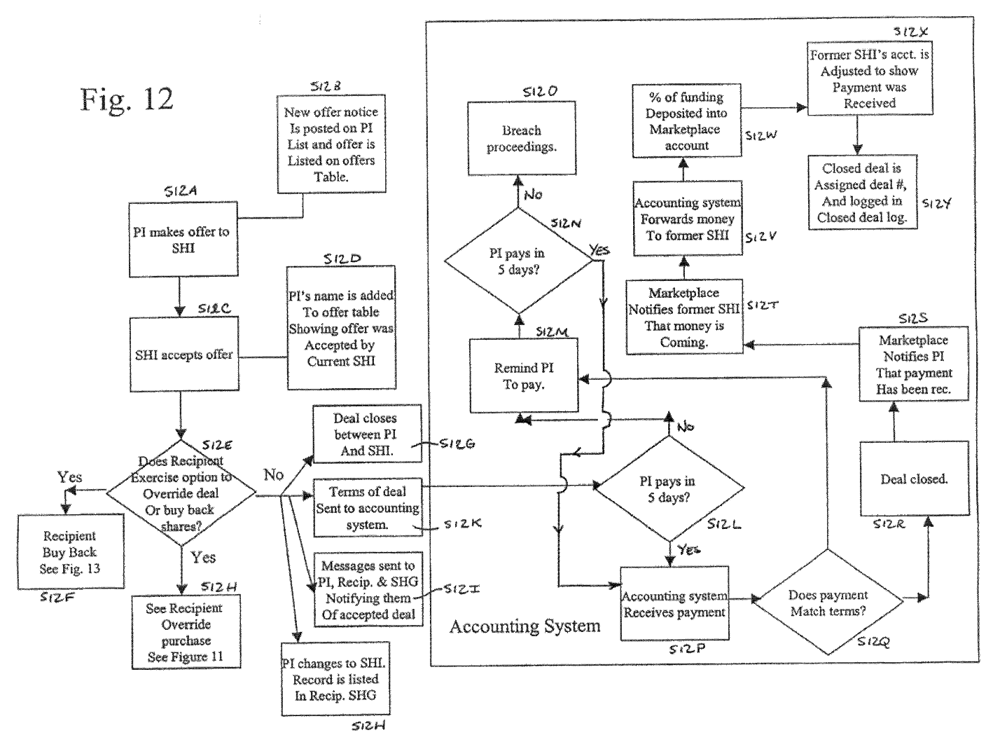

If the Recipient does not exercise his right to override the deal between the Potential Investor and the Share Holding Investor, then the process outlined in FIG. 12 which follows.

Deal-making Between Potential Investor and Share Holding Investor

Blocks S12A-S12F correspond respectively to blocks S11A-S11F of FIG. 11. Thus, in this case, the deal between the Potential Investor and the SHI is allowed to proceed (S12G). Block S12F corresponds to FIG. 13, and block S12H corresponds to FIG. 11 discussed above.

The terms of the deal between the PI and the SHI are sent to the accounting system (S12K). If the PI pays within the predetermined time limit (S12L,S12P) and payment matches the specifics of the deal (S12Q), then the deal is closed (S12R). The parties are then notified (S12S,S12T) and the payment is sent to the old SHI(S12V). A portion of which may be provided to the operator of the marketplace (S12W). The accounts of the involved parties are adjusted to show that payment was received by the old SHI(S12X), and the closed deal is assigned a number and logged into a database (S12Y).

If the payment does not match the specifics of the deal (S12Q) (or if payment is not initially received), the PI is reminded and given another time period in which to forward payment (S12M,S12N,S120). If payment is not received, then the SHI is notified (as well as the PI) that he may proceed with breach proceedings (S12O).

Deal Making Between Share Holding Investor and Recipient-Recipient Override OF PI's Offer to Buy-Buy Back

A Potential Investor makes offer to purchase from a SHI (S13A, S13B). The SHI accepts the offer from the PI (S13C), and the PIs name is added to the Offer Table, showing that the offer has been accepted (S13D). At this point, the Recipient may exercises his right to buy back his shares from the SHI(S13E) or override the purchase (S13F) or neither (S13G). If the Recipient wishes to buy back his shares, then the deal closes between the SHI and the

Recipient (S13H). The shares in question are removed from the SHI's account and placed in the Recipients account with a color coded background to indicate that payment is pending (S13I). Messages are then sent to the PI and the SHG (S13J).

Blocks S13M-S13Z4 illustrate the process for collection and tracking of payment, which is substantially similar to the previously recited processes described in the previous deal-making flowcharts. Accordingly, the terms of the deal are forwarded to the accounting system (S13M). If the Recipient pays within an allotted time period, and the payment matches the terms of the deal, then the deal closes, and the Recipient and SHI are notified that the deal is closed and the payment is forwarded to the SHI (with a percentage retained by the marketplace). See S13U-S13Y.

As with the previous deal-making flowcharts, the process provides for contingencies if payment is not received on time, or at all (see S13N,S13O,S13P, and S13Z).

Deal-making Between Share Holding Investor and Recipient-Buy Back of Shares

The Recipient may make an offer to a SHI to buy back his shares (S14A). Thus, the Recipients name is added to an Offer Table displayed to the SHG(S14B). If a SHI accepts the offer (S14C), the deal closes between them and the shares are removed from the SHI's account and placed in Recipient's account with color coding to indicate that payment has not yet been received (S14D,S14E). Depending upon the number of shares purchased, appropriate email messages are forwarded to the respective parties involved (S14F,S14G). Thereafter, the process continues with the terms of the deal being forwarded to the accounting system (S14H). The remainder of the process (S14I-S14T) is substantially similar to that of the later part of FIG. 13 (S13N-S13Z).

Recipient Paying Investor

When the Recipient has established an income in accordance with the terms of the deal, the marketplace sends a reminder that the Recipient must make payment to the SHG(S15A). If the Recipient pays within a predetermined period of time (S15B), the accounting system receives a copy of the Recipients 1040 statement and verifies that the Recipient's payment to each SHI is appropriate relative to the income stated on the 1040 form (S15B,S15C,S15D). If the payment is appropriate, the payment is processed (S15E), and payments are forwarded to the marketplace (S15L), and each SHI(S15M). The accounting system updates the marketplace database with the details of the payment (S15K).

The SHI make choose to verify the payment (S15N), at which point upon verification, the payment process is closed (S15P). If the payment is not correct (S15O), the SHI informs the Recipient of the correct amount to pay (S15Q). If the Recipient pays within a set time (S15R), then the accounting system also informs the Recipient of the correct amount (S15W, E59). If the Recipient pays within a set time thereafter, the process is picked up on block S15C.

If the Recipient does not effect payment, then breach proceedings may be initiated by the SHI(S15S,S15V,S15X).

Upon payment processing (S15E) the accounting system updates the details of the payment with the marketplace database (S15K). If the payment is for fixed return shares (S15F), then the system determines whether the payment satisfies the Recipient's obligation (S15G). If so, then the marketplace informs the SHI and SHG members that the relationship is terminated (S15H). If the payment does not satisfy the Recipient's obligation, or if the payment is not for fixed return shares, then the marketplace notifies the Recipient that payment has been received (S15J), and notifies the SHI of the amount of the next payment (S15I).

Fixed Return Offer Between Potential Investor and Applicant

In this scenario, a Potential Investor communicates with an Applicant, upon which an offer of funding is made for a fixed return (i.e., repayment of a specific amount as specified or later negotiated with the Applicant/Recipient) (S16A,S16B). The offer is posted on the Potential Investor list of the Applicant (S16C,S16D) and the Applicant is notified. If the Applicant accepts the offer (S16E), then messages are forwarded to the respective parties and the terms of the deal are sent to the accounting system (S16H). The status of the PI then changes to a SHI, but color coded to indicate that payment has not yet been received (S16I). Thereafter, blocks S16J-S16V detail the process of the transfer of payment and closing the deal.

Further Embodiments of the Present Invention

The following additional aspects of the present invention represent some further examples of how the present invention may be applied.

### Variable Return

The present invention may also be configured to allow for variations in the timing and amount of investor return. Specifically, the present invention may be configured to provide a variable payback. Specifically, the investor's return may be based only upon the individual achieving a minimum income over a particular period of time. For example, the base income may be to a yearly cost of living in a particular area, or may be based on a yearly national average. If the Seller's income is below that level, the investor collects nothing over the period of time specified. Thus, by only collecting on the variable income of an Seller, the Seller is granted a sense of security that they will avoid possible bankruptcy if their idea fails.

### College Tuition

Investors can invest in individuals seeking capital for education in exchange for a portion of the individuals income. Mentoring an individual with regard to this aspect may include guidance in curriculum and course selection. The mentoring may further include providing a job to the individual or finding a job for the individual after completion of his studies.

### Fund Investing

A fund is established by investors for a particular topic or area. For example, a fund is established for those seeking education in the medical profession. When the fund invests in an individual requesting capital for going to medical school, the investors of the find become the individuals mentors. This aspect provides Sellers with almost unlimited horizontal and vertical networking for the individual to not only succeed in medical school, but find residency positions and employment positions thereafter.

### Non-profit

Profits obtained through the methods and systems according to the present invention are directed to anything the fund provider wishes from cancer research to homeless shelters.

### Reverse Auction

In contrast to buying and selling shares in individuals by investors, individuals bid for investors capital by offering a larger percentage return, or better terms.

The present invention may be used in conjunction with any number of prior art methods and devices to improve performance, promote and provide additional services with the online marketplace. For example, the present invention may be used with:

an Internet Chat system, so that users may communicate real time through the marketplace;

credit card transaction-to allow investors to easily provide funding; and

sales of related and unrelated goods and services.

Having presented the present invention in view of the above described embodiments, various alterations, modifications and improvements are intended to be within the scope and spirit of the invention. Accordingly, the foregoing description is by way of example only and is not intended as limiting to the specific details and examples recited.

### EXAMPLE 1

Unregistered User—Martin McCarter, 21

11:30 AM Monday. Martin McCarter browses Marketplace.org from his dorm room. He is a college senior, and has been accepted at University of Michigan Law School, which he is incredibly excited about, but at the moment very worried about as well. Martin is the first person in his family to go to college, let alone graduate school, and he is really worried about how he will pay his tuition. His family will help him as much as they can, but he knows that their help will only cover a fraction of the annual tuition. Since his acceptance, he has been feverishly researching loan information, but a friend has told him about Marketplace. Her sister received investments towards her medical school tuition, and she intends to apply for financing for her anthropology PhD.

He reads the Learn More section, goes to check out the information in “About Marketplace”, and is intrigued by the concept. He knows that his friend's sister had several people who invested in her, one of whom really went the extra distance to help her get the residency she most wanted when she finished med school. He goes to browse the investor pool by industry—pretty impressive. There are actually some names here that he recognizes from the financial news, and some high-profile attorneys. There are definitely Potential Investors here who can give him the kind of financing he will need.

The vetting process that is available—the ability to communicate at length with a Potential Investor and perform a background check—also impresses him. He checks out the registration process, noting some of the information that he would need to give about himself and his financial needs. He thinks about what a serious step receiving an investment would be. He decides to see what else he can find out about Marketplace before he makes a move.

9:45 AM Wednesday. Martin logs back on to Marketplace.org. He has called his friend's sister to talk to her about her experience with Marketplace this far, and she has given him her thoughts on why seeking an investor in this way is better than a bank loan. He has also checked the company on Hoover's, and tracked down two other Recipients to talk with. Finally, he has talked the idea over with his family. They have mixed opinions, but ultimately it's his decision to make. He's decided to try it out—after all, he doesn't have to do anything he's not comfortable with.

He registers as an Seller; looking for assistance paying for law school, has been accepted at University of Michigan, plus his banking information. He enters the amount he will need for tuition—done. It was easier than filling out an online resume form. He feels a bit uneasy that there is not enough information for him to stand out as an Seller, and thinks about what additional information he could include in his profile.

3 PM Thursday. Martin logs on to Marketplace.org and enters his new user name and password. He is armed with several new files (like an digital copy of his acceptance letter from Michigan, his college transcript and senior thesis) and an improved statement of his funding needs.

He has a Potential Investor! He checks out the BBS message from Tom Green—pretty brief, wants more information about Martin, says that he is a Michigan Law grad, class of 1979 and has invested in two other Marketplace Sellers already. He clicks to check out Tom Green's profile; Thomas Green, Partner at Kirkland and Ellis, Real Estate practice!

Martin clicks on “Update Profile”, revises his statement of his funding needs, and adds his documents. He then returns to his main page, clicks on Tom Green and posts a message to him, thanking him for his interest and informing him that more information is now posted.

### EXAMPLE 2

Registered Seller—Pre-investment—David Tafelski, 32

11:30 Tuesday. Dave Tafelski logs in to his Marketplace.org account from work and checks his main page for messages from Potential Investors. Dave is a systems analyst, but he also writes fiction, and has published several short stories. For over a year he has been trying to write a novel in his off hours. He is frustrated by his progress to date and wishes he could work on the book full-time, he feels certain he will be able to get it published.

Dave has registered at Marketplace seeking funding to allow him to quit working for one year to complete the novel—he feels like it's a bit of a long shot, but what does he have to lose? He has posted several chapters of the book, as well as his published stories, and is seeking $35,000.

So far, he's gotten a bit of interest, but no bites. Several Potential Investors have contacted him with questions, and claim to have read his stuff. He's been doing a bit of a dance with a couple of them—they seem interested, but obviously he is a fairly high-risk investment. He checks his PI list for new messages. One from Bill Auden, a lawyer, asking about his “process”—he suspects this guy is never going to invest, he is just entertaining himself. Another from Jim Turner, a stockbroker, asking him if he has a strategy for selling the book once it is complete, and how he would want to see it marketed. Good questions, but hard to think about right now, with the book so far from finished. Still, he composes a reply, detailing the literary agents he's made contact with, and why he thinks the book would sell well if properly marketed. Dave feels that Jim Turner is really interested, but is nervous about investing in him.

There's a message from a new Potential Investor, Jane Haupt-Wolff, informing him that she has read his posted work and thinks it's very good, wants to know how he plans to complete the book if he gets his funding. He clicks to check out her profile—very interesting! She is a retired publishing executive, prepared to invest up to $10,000. Dave is very excited—here's someone who may understand better what he's trying to do. He replies to her, thanking her for the feedback and informing her that the investment will cover his living expenses in NYC and his health insurance, and also telling her that he is posting a revised chapter.

He clicks on Add Supporting Info and replaces his most recent chapter with the revision. He is very excited.

9 AM Wednesday. Dave checks his Marketplace account—there's a message from Jane Haupt-Wolf! She has read the revision, likes his changes—and she would like to learn a bit more about him. He replies to her immediately with more details about the book, about his writing history. She is also online, and they BBS back and forth in real-time, her filling him a bit about her experiences in publishing at Knopf.

At the end of their chat, she tells him that she's seriously considering his application—she isn't terribly concerned with the return, but she thinks he has great potential as a writer. Dave is so excited he can barely contain himself. He offers to supply any further information she might need to make a decision.

They finish their chat. Dave is practically jumping out of his skin. He thinks for a moment about whether he's being too optimistic, but then goes ahead and requests a background check on Jane Haupt-Wolff—he wants to find out if this lady is for real. He enters his credit card number, reasoning that it is a worthwhile expense.

He then returns to his main page and notes that he has a new Potential Investor and checks his message and profile. A retired physician, he considers himself to be an investor of the arts and likes Dave's writing. Great! Dave replies to his message.

11:45 AM Friday. Dave logs on and checks his main page—Jane Haupt-Wolff has made an offer!! He clicks on the offer and looks at the deal page—she has offered him $7,000! He can't believe it, he has to try to calm down. He carefully reviews the terms she has proposed, and tries to decide how best to respond. Of course he wants to accept immediately, but he needs to be more professional. The background check should be back imminently, in the meantime he sends a message to Jane Haupt-Wolff immediately thanking her for the offer and telling her he will respond to it ASAP.

9:30 AM Monday. Dave checks his regular email account—the background check has come back. Jane Haupt-Wolff is the real deal, she is who she says she is, she can certainly afford the deal she proposes. He reviews the offer a final time, and then accepts it. He returns to his main page and sees he has a message from Marketplace noting his acceptance of the offer. Now all he can do is wait and see.

10 AM Wednesday. Dave logs on for the 20th time to check the status of his deal with Jane Haupt-Wolff—his main page has changed! He now sees a new table listing Jane Haupt-Wolff as an active investor, as well as a message from Marketplace informing him that her investment has been transferred to his bank. He calls the bank to verify—amazing. He immediately shoots Jane Haupt-Wolff a message thanking her for the investment, and reaffirming his intent to let the money sit and not make a move until he gets close to his funding goal. He has a ways to go! But if he gets as close as $25,000, he thinks he will give notice and do without health insurance. All he wants to do at the moment is write.

Dave also notices that there are new messages from all three of his other Potential Investors. Jane Haupt-Woff's investment has not gone unnoticed! He replies to all three, letting them know that yes indeed, a retired publishing exec has invested in him, and waits to see their responses.

### EXAMPLE 3

Registered Investor—Pre-investment—Rick Milsten, 58

10:30 AM Sunday. Dr. Rick Milsten checks onto his new Marketplace account—just opened last week. He is finding retirement pleasant, if a little boring. He looks at his Seller watch list, two college students hoping for help with med school, one of whom has been accepted to the University of Alabama at Birmingham program and one of who is waiting to hear from Johns Hopkins (but has been accepted at the University of Chicago). He has a message from the prospective UAB student, he has updated his profile and is inviting him to review it.

But first, Rick decides to search the Seller database. He enters “Urology”, his former practice, and then refines the search; any location, medical school, $5,001-$10,000 investment. He comes up empty. No one seems to be interested in Urology at the outset, it's a shame. He searches again, substituting “female” for “Urology”—if he can't add to the practice, he can at least do his own social engineering, plus if he invests in someone he can always encourage them to consider Urology. Much better results, 10 profiles to review. He scrolls through, clicking occasionally to view an Seller's profile, then clicking back to his search results.

After reviewing them all, he adds two to his watch list, one gal who plans to go to the University of Washington, and one who has been accepted to UCSF, but took a year off prior to work in a reproductive health clinic. He'll keep an eye on all of them.

4:30 PM Monday. Dr. Milsten returns from his golf game, checks his email and receives a picture of his granddaughter at gymnastics class, and an email that he has new messages at Marketplace.org. He logs on to his account to see what's up. He notes that his UW prospect has snagged an investor who has taken 40 of her shares—good for her.

There are new messages from all four of the Sellers on his watch list. Two are simply thanking him for his interest, but one has again updated their profile to reflect his acceptance to Hopkins, and UCSF says that she has read his book on male sexuality, and found it fascinating. Flattering—perhaps she will be the future urologist. He does a quick search again, this time for all med school Sellers, but feels a bit overwhelmed by his search results.

He checks on a few of the clearly hot Sellers in his search results that already have several investors, but he figures that they are already ahead of the game. Dr. Milsten considers this type of investment a relatively safe one given physicians' potential earnings, and to be honest, his return is not his greatest motivator. He feels certain that if he chooses well, he'll get his investment back, and that is all that's really necessary to him.

8:45 PM Tuesday. Rick discussed making a $20,000 investment at Marketplace with his wife Nancy at dinner. She is a lawyer who no longer practices, but still does some consulting work. She thinks it's an interesting concept, and encourages him to pick a Recipient, or Recipients. He logs on after dinner to re-evaluate his watch list. Who is most deserving, and who has the best prospect for success? And should he split his investment among prospects, or give it all to one? So many factors . . . he reviews his potentials' profiles, and checks out the profile of UW's investor—a lawyer in Dallas. Rick posts a message inquiring what made this individual an attractive investment.

He then sends his UCSF prospect a message asking her why she elected to delay her entrance to school for a year to work in a clinic, when she will have quite a bit of time in the trenches when she is a resident. She is also online, and replies immediately, saying that she had many reasons, including financial, but also she wanted to be sure about her career choice before embarking on such a difficult and costly education. They message back and forth, and she elaborates on the things she's learned while working in reproductive health, the reasons she has decided not to be an Ob/Gyn, and some of the questions that reading Dr. Milsten's book raised for her. He feels very satisfied with the exchange—she is an articulate young woman.

12:30 PM Wednesday. Rick has slept on it, and has made a couple of decisions; he's definitely going to seek female Sellers to invest in, as he feels that there need to be more qualified female physicians entering the workforce, and in addition he will find more than one Recipient. It is tempting to throw it all to one student, and know that you're making a big impact and enjoy their gratitude, but reason dictates that it's wiser to spread out his investment among several prospects.

He logs on to check his messages, and there is a reply posted from Dan Melman, the lawyer who has invested in the prospective University of Washington student. Melman says that he has invested in 6 med students/physicians on Marketplace.org, and he vets them according to their undergraduate performance, obviously their acceptance to a top medical school, their stated intent to practice, and of course their background check. He says that he is already seeing returns on two physicians' earnings, and that he only invests in individuals who have stated an interest in a lucrative specialty, in UW's case dermatology. He thinks UW is an excellent candidate, very stable and clear about her goals.

Rick requests background checks on two Sellers—UW and UCSF. He then worries that he may be missing someone great out there, and conducts a new Seller search, for female medical students. This time he is considerably more interested in the number of shareholding investors each has. He adds two new prospects to his watch list, and removes UAB and Johns Hopkins, as they are not female. It occurs to him that he will probably not be able to subject a female Recipient to all of the great dirty urology jokes he has collected over the years . . .

3:30 PM Friday. Having had a busy couple of days, Dr. Milsten checks his email, and receives the background checks on both of his prospects. They both check out. He also has an email informing him of messages at Marketplace.org, and he logs on to check the situation. He immediately realizes that U. Washington has sold all of her shares, effectively taking her off of the market for the moment—it doesn't seem logical to try to buy from her shareholding group when she hasn't even entered school! UCSF has also sold half of her shares—he figures if he is interested, he had better consider making an offer to her. Which he does, for $10,000. He then checks on the status of the rest of his watch list.

12 PM Thursday. A week later, Dr. Milsten has closed the deal with UCSF, and has made another offer to a hot prospect going to Harvard Med. He is also keeping an eye on UW, just to see what happens with her.

### EXAMPLE 4

Recipient—Cheryl Cowell, 29

3:30 AM Tuesday. Cheryl Cowell receives an email that there is activity in her Recipient account at Marketplace.org. She has been working for many hours to complete a major deal in Hong Kong, so she decides to take a break and check out what's up, plus she has new information to add to her profile—the article about her from Black Enterprise, and her own article in Business 2.0. She logs on to check out what is going on with her investors—she is two years out of Harvard Business School, and she did not have to pay a dime, her tuition was fully funded.

She sees a message informing her that a Robert Johnson has offered to buy 30 of her shares from Irving Geszel, her very first investor, at a surprisingly inflated price. She clicks on her potential new investor's profile to see what the deal is. Surprise! It's THAT Robert Johnson. Not bad.

Cheryl is a bit torn. She definitely plans to eventually buy back her shares, and she figures she should do so before her net worth increases too much, making her much more attractive as a long term investment! But she thinks that if an investor like Robert Johnson is interested in her, it would be foolish to try to outbid him—except as an attention-getting ploy. No, better to keep him in the loop about what she's up to as an investor! She decides not to match the bid.

She posts a message to the BBS, and suggests that they both check out her updated profile. She also hints in her message that an idea she has been working on for a business is almost ready for the public eye. Cheryl has developed a business plan for a proprietary wireless application that she wants to put into motion as soon as possible, and is debating where the best place to seek financing would be. While she is quite confident that she could raise the money on Marketplace.org, she is equally confident that she could raise it from her individual pool of investors and their contacts, with potentially less personal liability. Exhausted, Cheryl logs off and goes to bed.

### EXAMPLE 5

Shareholding Investor—Irving Geszel, 62

6:30 PM Monday. Irving Geszel logs on to his Marketplace.org account to check on his investments. Irving is a “semi-retired” financial analyst, worked at Bear Stearns for 35 years. He checks out his main page, with eight Recipient's shareholder groups and 15 Sellers on his watch list. He has quite a few new messages from Potential Investors making him offers on his investments, and of course numerous messages from his watch list. Irving is eagle-eyed about his watch list, noting all new activity around the individuals he has marked as interesting.

He sees he has a bid from Robert Johnson, who he knows slightly. Johnson is interested in one of Irving's early investments, Cheryl Cowell, a very bright young lady who is determined to succeed and is impatient with traditional methods. Irving thinks she is an excellent long-term investment, but also something of a hothead who will insist on doing everything her own way. For the price Johnson is offering, he's going to consider it, he will still retain half of his shares in Cowell, and he doesn't believe she will begin earning the really big bucks for several years. He replies to Johnson, asking him to sweeten his bid.

He then checks on all of his Recipients, checks any new information posted, and checks his returns. Two of the lawyers he invested in are already paying off in spades, they work in corporate litigation and real estate law, respectively. He also requests background checks on three of his watch list people, and makes an offer to a Recipient in whom he already holds three shares. The kid is a scrapper, and only needs $10,000 more for his tuition.

Before logging off, Irving conducts a quick Seller search. “Harvard”, “Yale”, “Stanford”, and “medical school” are his most common keywords, though he also uses “proprietary” “technology” “biotech” and a few others with some frequency. He only invests in what he considers to be the very best, there are no charity cases in Irving's world. He loves Marketplace.org, after a lifetime of calculated and lucrative risk, he has found a colossally engaging new way of investing. He adds a couple of Sellers to his watch list.

11:30 AM Tuesday. Irving checks back at Marketplace.org—new message from Robert Johnson about Cheryl Cowell—he'll sweeten his offer. Does he know something Irving doesn't? Hmmm. There's also a message from Cheryl herself, telling them that she's updated her profile with new information, and hinting at a new business scheme. Are she and Johnson colluding on something offline?

After mulling it over, Irving decides not to sell to Johnson. Let him make an offer to the other two people in Cheryl's shareholding group, and Irving will maintain his majority stake. If Johnson is that interested in her, there's got to be a reason. He declines the bid.

He scrolls through his Seller watch list again, answering messages and checking on their profiles and documents. There is a business plan in one young man's application that he would like to re-examine, and just for fun he has selected a screenwriter to keep an eye on. He's going to give the script to his son out in LA to read, if Mike likes it who knows? Maybe that's an interesting new investment . . . you never know.

Having presented the present invention in view of the above described embodiments, various alterations, modifications and improvements are intended to be within the scope and spirit of the invention. The foregoing description is by way of example only and is not intended as limiting. The invention's limit is defined only in the following claims and the equivalents thereto.

What is claimed is:

1. A method for providing funding to an individual by an investor comprising:
communicating a request for funding for an individual to an investor;
associating said request for funding with a cost for a share in said individual, wherein a purchaser of said share receives an economic return comprising a percentage of said Seller's income
offering said share for sale;
purchasing said share by a purchaser at a purchase price.

2. The method according to claim 1, wherein offering said share for sale comprises auctioning said share, and wherein purchasing said share comprises submitting a highest purchase price.

3. The method according to claim 2, wherein said highest purchase price comprises a monetary amount equal to at least said cost of said share.

4. The method according to claim 1, wherein said purchase price comprises said cost of said share and a mentoring capability of said purchaser.

5. The method according to claim 1, wherein said individual's income comprises individual's potential future income.

6. The method according to claim 1, wherein said percentage is variable.

7. The method according to claim 1, wherein said percentage comprises approximately 0.

8. The method according to claim 1, wherein said funding request comprises at least one of college tuition, forming a business, and/or developing an idea.

9. The method for providing funding according to claim 1, wherein said funding request is associated with a plurality of shares, each said share being associated with a portion of said funding and a portion of said percentage of said individual's potential future income.

10. The method for providing funding according to claim 1, wherein said funding request is associated with a plurality of shares, each said share being associated with an equal portion of said funding and an equal portion of said percentage of said individual's potential future income.

11. The method according to claim 1, wherein said percentage is greater than 0 and less than about 50.

12. The method according to claim 1, wherein said percentage is greater than 0 and less than about 25.

13. The method according to claim 1, wherein said percentage is greater than 0 and less than about 10.

14. The method according to claim 1, wherein said purchaser comprises a purchasing group comprising a plurality of individual purchasers.

15. The method according to claim 1, wherein said percentage return is directed toward a second entity apart from said purchaser.

16. The method according to claim 15, wherein said second entity is a charitable organization.

17. The method according to claim 15, wherein said second entity is a non-profit organization.

18. A method for buying and selling a share in an individual, comprising
communicating an offer for sale of a share in an individual for a first price by an owner of said share, wherein ownership of said share confers a percentage of said individual's income;
submitting at least one bid on said share by at least one purchaser, wherein said bid comprises a second price;
communicating an acceptance of said bid at said second price, wherein ownership of said share is transferred to said purchaser.

19. The method according to claim 18, wherein said second price is less than said first price.

20. The method according to claim 18, wherein said second price is substantially equal to said first price.

21. The method according to claim 18, wherein said second price is greater than said first price.

22. The method according to claim 18, further comprising placing a plurality of bids on said share.

23. The method according to claim 18, further comprising placing a plurality of bids on said share, wherein each bid is associated with a particular purchaser.

24. The method according to claim 22, wherein said plurality of bids are placed over a predetermined period of time.

25. The method according to claims 22, wherein said share is awarded to the purchaser placing the highest bid.

26. The method according to claim 23, wherein said plurality of bids are placed over a predetermined period of time.

27. The method according to claims 23, wherein said share is awarded to the purchaser placing the highest bid.

28. The method according to claim 22, wherein said highest bid comprises a bid having the highest offered price and greatest amount of mentoring.

29. The method according to claim 23, wherein said highest bid comprises a bid having the highest offered price and greatest amount of mentoring.

30. Computer readable media including computer code comprising instructions for performing a method for providing funding to an individual by an investor comprising:
communicating a request for funding for an individual to an investor;
associating said request for finding with a cost for a share in said individual, wherein a purchaser of said share receives an economic return comprising a percentage of said Seller's income
offering said share for sale;
purchasing said share by a purchaser at a purchase price, wherein said purchase price comprises said cost of said share.

31. Computer readable media including computer code comprising instructions for performing a method for buying and selling a share in an individual, comprising
communicating an offer for sale of a share in an individual for a first price by an
owner of said share, wherein ownership of said share confers a percentage of said individual's income;
submitting at least one bid on said share by at least one purchaser, wherein said bid comprises a second price;
communicating an acceptance of said bid at said second price, wherein ownership of said share is transferred to said purchaser.

32. A computer system comprising:
storage means for storing data; and
a processor programmed to performing a method for buying and selling a share in an individual, comprising:
communicating a request for finding for an individual to an investor;
associating said request for funding with a cost for a share in said individual, wherein a purchaser of said share receives an economic return comprising a percentage of said Seller's income
offering said share for sale;
purchasing said share by a purchaser at a purchase price, wherein said purchase price comprises said cost of said share.

33. A computer system comprising:
storage means for storing data; and
a processor programmed to perform a method for providing funding to an individual by an investor comprising:
communicating an offer for sale of a share in an individual for a first price by an owner of said share, wherein ownership of said share confers a percentage of said individual's income;
submitting at least one bid on said share by at least one purchaser, wherein said bid comprises a second price;
communicating an acceptance of said bid at said second price, wherein ownership of said share is transferred to said purchaser.

34. A method for selling shares in a marketplace, said shares comprising an interest in a future potential income of an individual, said method comprising:
communicating an availability of a share for purchase to an investor for a minimum price and a mentoring capability;
selling said share to an investor offering at least said minimum price and offering the highest mentoring ability.

35. A method for providing personal funding opportunities to Sellers comprising:
registering a plurality of requests for capital in a database, wherein said request comprises a monetary amount and reasons for such request, and wherein each request being associated with a particular Seller;
associating each said request with an economic return to an investor providing said capital to said Seller, wherein said economic return comprises a percentage of said Seller's income;
providing a first Seller with said respective requested capital by a first investor;
wherein said first investor also provides said first Seller with mentoring.

36. A method for obtaining personal funding in exchange for a rate of return in an individual's potential future income comprising:
registering a plurality of offers for providing funding in a database, wherein each said offer comprises a monetary amount, and wherein each offer being associated with a particular investor;
bidding on said offers by an individual seeking funding, wherein a bid comprises an offer for a percentage of said individual's potential future income;
awarding said funding to a first individual who bids a highest percentage of potential future income.
